(19) United States
(12) Patent Application Publication
(10) Pub. No.: US 2006/0002119 A1
(43) Pub. Date: Jan. 5, 2006

(54) Bicycle headlight

(76) Inventor: Simon Sharp, Lancashire (GB)

Correspondence Address: ADAMS EVANS P.A., 2180 TWO WACHOVIA CENTER, CHARLOTTE, NC, 28282, US

(21) Appl. No.: 11/005,252

(22) Filed: Dec. 6, 2004

(30) Foreign Application Priority Data
Jun. 30, 2004 (GB) GB 0414586.8

(51) Int. Cl. B62J 6/00

(52) U.S. Cl. 362/473

(57) ABSTRACT

A light mountable on a handlebar of a vehicle, and including a light unit, including a light-emitting element, such as an incandescent bulb or light-emitting diode, and a battery housing for containing at least one battery for supplying electricity to the light-emitting element and a mounting on which the light unit is carried. The mounting is adapted for adjustable attachment to a handlebar. A secondary battery pack housing is carried by the mounting for containing a battery, and includes an electrical interconnection with the light-emitting element. Alternatively, the battery pack housing may be the sole source of electric current for the light-emitting element.

### TECHNICAL FIELD AND BACKGROUND OF THE INVENTION

Bicycle headlights are traditionally releasably coupled to the handlebars, frame or forks of a bicycle by a user-mounted bracket. However, fitting a bracket securely in a suitable position can be difficult. Furthermore, the bracket failure or unwanted release of a headlight from a bracket can lead to the headlight falling to the ground. A headlight that falls to the ground is likely to be seriously damaged. Some prior art headlights comprise a battery pack intended to be mounted remotely from a light unit, e.g. in a bottle cage or by strapping to a bicycle frame. However, this requires a long interconnection between the battery pack and the light unit, which is inconvenient. Also, in use the interconnection and/or the battery pack may cause damage to the frame.

It is an aim of preferred embodiments of the present invention to allow a bicycle headlight to be coupled to a bicycle using simple tools and with added security against unwanted release of the headlight.

### SUMMARY OF THE INVENTION

According to a first aspect of the present invention there is provided a bicycle headlight comprising a light unit including means for coupling the light to a stem front clamp.

According to a second aspect of the invention there is provided a stem front clamp comprising a mounting for receiving a light unit of a bicycle headlight.

According to a third aspect of the invention there is provided a bicycle headlight kit including: a stem front clamp comprising a mounting for receiving a light unit of a bicycle headlight; and a light unit including means for coupling the light unit to the mounting.

According to a forth aspect of the invention there is provided a bicycle headlight comprising a light unit mounted to a stem front clamp.

Suitably, the light unit can be pivotally coupled to the stem front clamp. Suitably, the pivotal coupling allows the angle of the light unit to the horizontal to be adjusted when the stem front clamp is in place on a bicycle stem. Suitably, the light unit is releasably coupleable to the stem front clamp at the mounting. Alternatively, the light unit may be fixedly coupled to the stem front clamp.

Suitably, the light unit is self contained. Suitably, the light unit comprises an electrical connector arranged to allow battery packs to be coupled thereto.

### BRIEF FIGURE DESCRIPTION

For a better understanding of the invention, and to show how embodiments of the same may be carried into effect, reference will now be made, by way of example, to the accompanying diagrammatic drawings in which:

FIG. 1 shows a perspective view of a first preferred embodiment of the light coupled to a bicycle handlebar stem;

FIG. 2 shows a perspective view of a second preferred embodiment of the light coupled to a bicycle handlebar stem;

FIG. 3 is simplified perspective view of a bicycle having a third preferred embodiment of the light coupled to a bicycle handlebar stem;

FIG. 4 is an enlarged view of the handlebar and stem portions of the bicycle shown in FIG. 3; and

FIG. 5 is a further enlarged view of the handlebar portion and light as shown in FIGS. 3 and 4.

### DESCRIPTION OF PREFERRED EMBODIMENTS AND BEST MODE

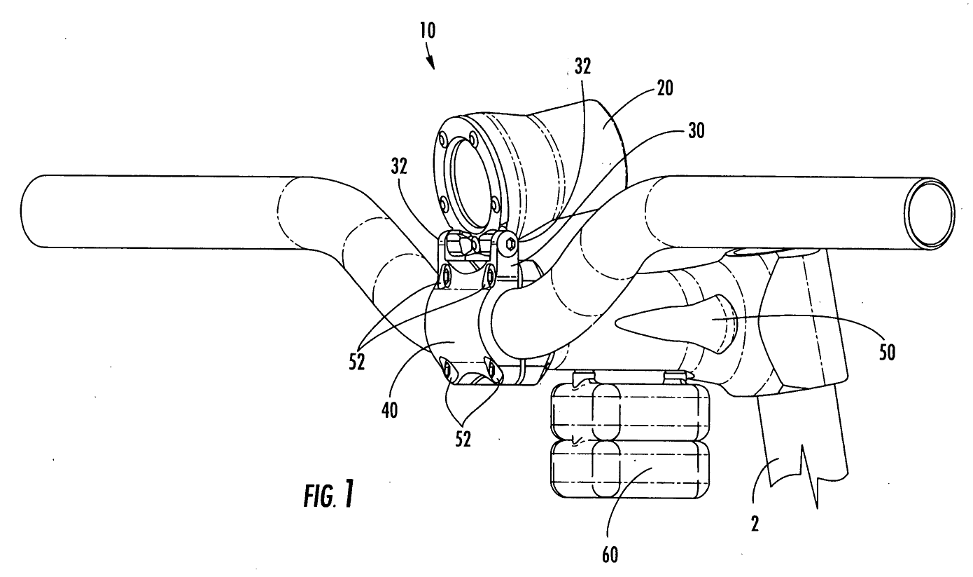

Referring now to the drawings, FIG. 1 shows a bicycle headlight 10 comprising a light unit 20 and a mounting 30. The mounting 30 comprises a pivotal coupling between the light unit 20 and a stem front clamp 40. Also shown in FIG. 1 are handlebars 1 and steerer tube 2.

The mounting 30 allows the headlight 10 to be bolted in place to a bicycle stem 50 using bolts 52. In this way the headlight 10 is securely fixed to the bicycle, so there is no risk of the headlight 10 falling from the bicycle. The light unit 20 is self contained, in that no additional batteries or electrical connections are required over and above those provided in or on the light unit 20 in order for the headlight 10 to function. The light unit 20 includes a light-emitting element such as one or more incandescent bulbs, light emitting diodes or high intensity discharge (HID) light source.

The pivotal coupling can be used to adjust the angle of the light unit 20 to the horizontal, so that a desired illumination range is achieved. The mounting 30 comprises locking bolts 32 that are adjustable to hold the light unit 10 at a required angle to the horizontal.

The stem front clamp 40 can be provided with one of a range of arrangements of bolts 52 to allow the headlight 10 to be fitted to an existing stem as a replacement front clamp. For example, as an alternative to the four bolt design shown in FIG. 1, a two bolt arrangement is possible with bolts 52 positioned at the top and bottom centres of the stem front clamp 40. Alternatively, the headlight 10 can be supplied with a replacement stem adapted to receive the stem front clamp 40.

Also shown in FIG. 1 is a battery pack 60. The battery pack 60 can optionally be strapped to the stem 50, and is used to supplement batteries contained within the light unit 20, allowing a longer illumination time between battery charges or replacement. A wire or other connection means such as a hot shoe, or plug connectors (not shown) connects the battery pack 60 to an electrical connector on the light unit 20.

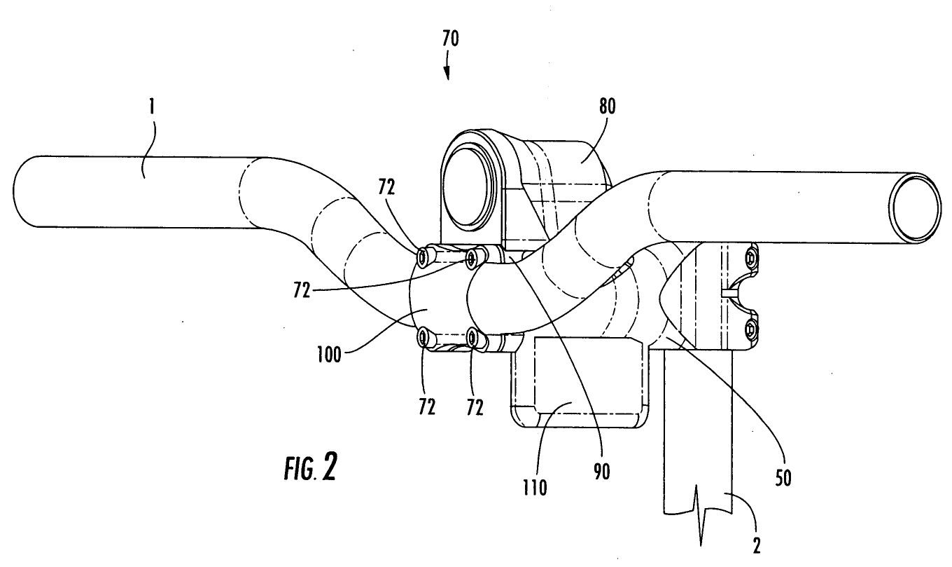

Referring now to FIG. 2, a light 70 is shown, featuring an alternative mounting. The light comprises a light unit 80 and a mounting 90. The mounting 90 comprises a pivotal coupling between the light unit 80 and a stem front clamp 100 for mounting the light on the handlebars 1.

The mounting 90 allows the headlight 70 to be bolted in place to a bicycle stem 50 using bolts 72. In this way the headlight 70 is securely fixed to the bicycle, so there is no risk of the headlight 70 falling from the bicycle. The light unit 80 is self contained, in that no additional batteries or electrical connections are required over and above those provided in or on the light unit 80 in order for the headlight 70 to function.

The mounting 90 can be used to adjust the angle of the light unit 80 to the horizontal, so that a desired illumination range is achieved. This is accomplished by loosening the bolts 72 sufficiently to allow the light unit 80 to be pivoted on the handlebar to the desired angle, and then retightening the bolts 72.

The stem front clamp 100 can be provided with one of several arrangements of bolts 72 to allow the headlight 80 to be fitted to an existing stem as a replacement front clamp. For example, as an alternative to the four bolt design shown in FIG. 1, a two bolt arrangement is possible with bolts positioned at the top and bottom centres of the stem front clamp 100. Alternatively, the headlight 70 can be supplied with a replacement stem adapted to receive the stem front clamp 100.

Also shown in FIG. 2 is a battery pack 110. The battery pack 110 can optionally be strapped to the stem 50, and is used to supplement batteries contained within the light unit 80, allowing a longer illumination time between battery charges or replacement. A wire or other connection means such as a hot shoe, or plug connectors (not shown) connects the battery pack 110 to an electrical connector on the light unit 80.

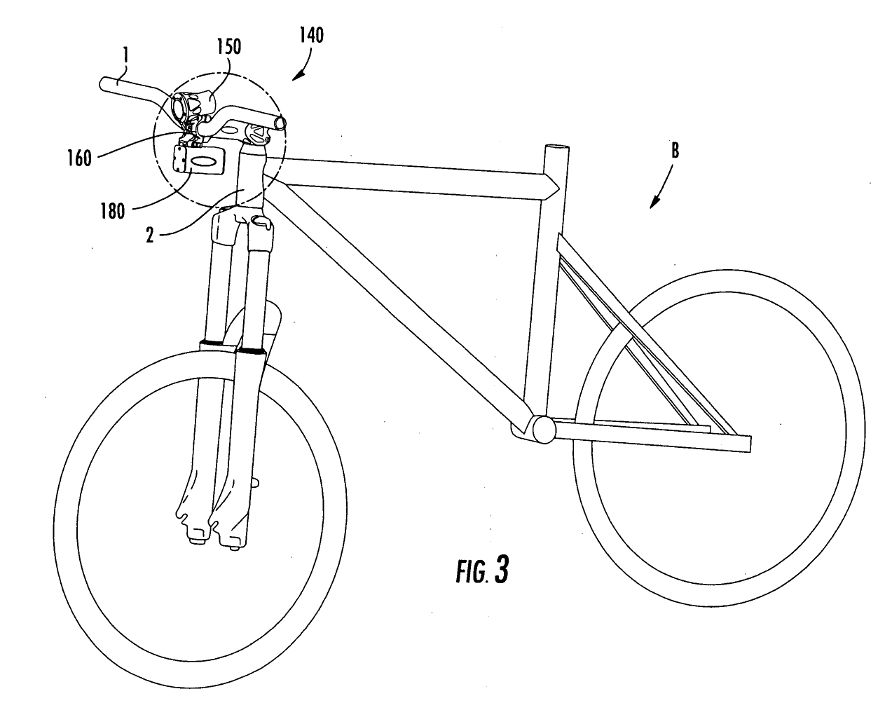

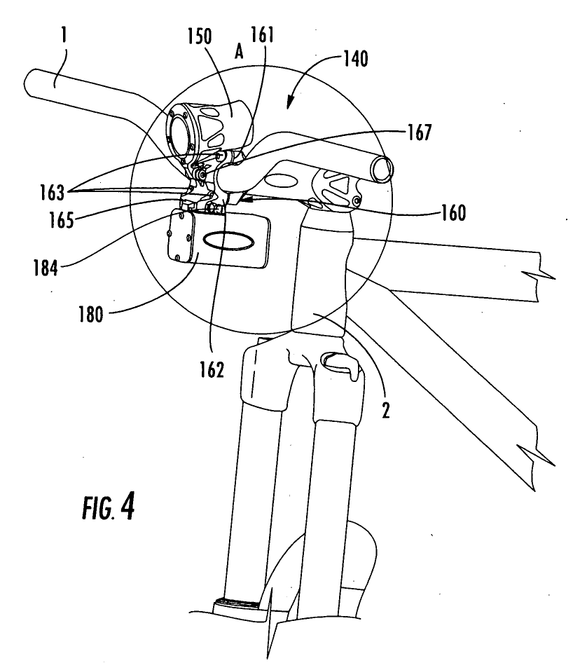

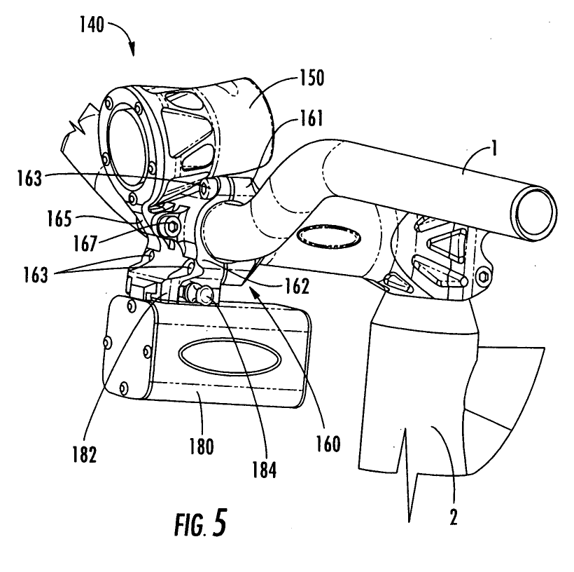

Referring now to FIGS. 3-5, a further embodiment of the light is shown and indicated generally at reference numeral 140, and mounted to a conventional bicycle “B.” As is most clearly shown in FIGS. 4 and 5, The light 140 comprises a light unit 150 and a mounting 160. The mounting 160 comprises first and second bracket members 161, 162 joined by bolts 163 to clamp the mounting 160 onto the handlebar 1. The light unit 150 is self contained, in that no additional batteries or electrical connections are required over and above those provided in or on the light unit 150 in order for the headlight 140 to function.

The mounting 160 also includes pivot bracket 165 mounted to the front of the mounting 160 in order to adjust the angle of the light unit 150 to the horizontal, so that a desired illumination range is achieved. This is accomplished by loosening a bolt 167 sufficiently to allow the light unit 150 to be pivoted on the handlebar to the desired angle, and then retightening the bolt 167.

Also shown in FIGS. 3-5 is a battery pack 180. The battery pack 180 is mounted on a bracket 182 attached to the bottom of mounting 160. The battery pack 180 is released by a quick release bolt 184 that normally maintains the bracket 182 in a locked position on the mounting 160. The batter pack contains an electrical connection to the light unit 150 through appropriate wiring, hot shoe or plug assembly. The battery pack 180 may be the sole power supply for the light unit 150 or may be used to supplement batteries contained within the light unit 150, allowing a longer illumination time between battery charges or replacement.

Although the word “bicycle” has been used throughout, it is to be understood that this term also encompasses tricycles, four-wheeled cycles and a range of other land or water vehicles having a handlebar arrangement including a stem. The bicycle headlight described can be conveniently and securely attached to a bicycle. The headlight is robust, easy to adjust and relatively secure against theft.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

I claim:

1. A light mountable on a handlebar of a vehicle, comprising:
(a) a light unit, including a light-emitting element and a battery housing for containing at least one battery for supplying electricity to the light-emitting element;
(b) a mounting on which the light unit is carried, the mounting being adapted for adjustable attachment to a handlebar; and
(c) a secondary battery pack housing carried by the mounting for containing a battery, and including an electrical interconnection with the light-emitting element.

2. A light according to claim 1, wherein the light unit includes a pivot for permitting the aiming point of the light unit to be adjusted.

3. A light according to claim 1, wherein the mounting includes first and second bracket members joined by bolts to clamp the mounting onto the handlebar.

4. A light according to claim 1, wherein the secondary battery pack includes a release for releasably interconnecting the secondary battery pack with the mounting.

5. A light according to claim 1, wherein the light emitting element is selected from the group consisting of incandescent bulb, light-emitting diode and high-intensity discharge (HID) light.

6. A light mountable on a handlebar of a vehicle, comprising:
(a) a light unit, including a light-emitting element;
(b) a mounting on which the light unit is carried, the mounting being adapted for adjustable attachment to a handlebar; and
(c) a battery pack housing carried by the mounting for containing a battery, and including an electrical interconnection with the light-emitting element.

7. A light according to claim 6, wherein the battery pack comprises the sole source of electric current for the light-emitting element.

8. A light mountable on a handlebar of a vehicle, comprising:
(a) a light unit, including a light-emitting element and a battery housing for containing at least one battery for supplying electricity to the light-emitting element;
(b) a mounting on which the light unit is carried, the mounting being adapted for adjustable attachment to a handlebar;
(c) a secondary battery pack housing carried by the mounting for containing a battery, and including an electrical interconnection with the light-emitting element;
(d) a pivot carried on the light unit for permitting the aiming point of the light unit to be adjusted;
(e) the mounting including first and second bracket members joined by bolts to clamp the mounting onto the handlebar; and
(f) the secondary battery pack including a release for releasably interconnecting the secondary battery pack with the mounting.
